(19) United States
(12) Patent Application Publication
(10) Pub. No.: US 2010/0214196 A1
(43) Pub. Date: Aug. 26, 2010

(54) Plasma Display Provided With an Array of Concentrators

(76) Inventor: Philippe Browaeys, Puteaux (FR)

Correspondence Address: Robert D. Shedd, Patent Operations;THOMSON Licensing LLC, P.O. Box 5312, Princeton, NJ, 08543-5312, US

(21) Appl. No.: 12/085,395

(22) PCT Filed: Oct. 31, 2006
(86) PCT No.: PCT/EP2006/067977

§ 371 Date: May 22, 2008

(30) Foreign Application Priority Data
Nov. 24, 2005 (FR) 0553598

(51) Int. Cl. G09G 3/28

(52) U.S. Cl. 345/60

(57) ABSTRACT

Display comprising a front panel, an array of optical concentrators, which operate by reflection, and an array of plasma discharge cells capable of emitting light through the front panel and through the concentrators, where each plasma discharge cell is optically coupled to at least one concentrator. According to the invention, the concentrators are bonded to one and the same layer which includes electromagnetic screening means. The manufacture of the display is thus simplified.

The invention relates to an image display comprising a front panel, an array of optical concentrators, and an array of plasma discharge cells capable of emitting light through said front panel and through the concentrators of said array, where each plasma discharge cell is optically coupled to at least one concentrator.

Documents EP 1 526 561, JP11-260269 and JP64-010544 describe such a display in which the light is concentrated in particular by lenses. These are therefore concentrators operating by refraction.

Other documents describe the application of concentrators operating by reflection to image displays other than plasma displays, for example U.S. Pat. No. 6,504,981 and U.S. Pat. No. 5,598,281, or to plasma displays, for example US 2004/108980.

In document EP 1 526 561, the array of concentrators comprises, on the one hand, an array of lenses and, on the other hand, an array of diaphragms. The diaphragms are formed by holes made in an opaque layer that also serves to enhance the contrast.

One drawback of this array of concentrators is that it requires the holes in the opaque contrast enhancement layer to be aligned with respect to the optical axis of the lenses. This poses a problem during manufacture of the display.

Another drawback lies in the production of two plates (referenced 120 and 123) of different indices having complementary curved faces so as to form the array of lenses. Such a construction is complex and poses problems.

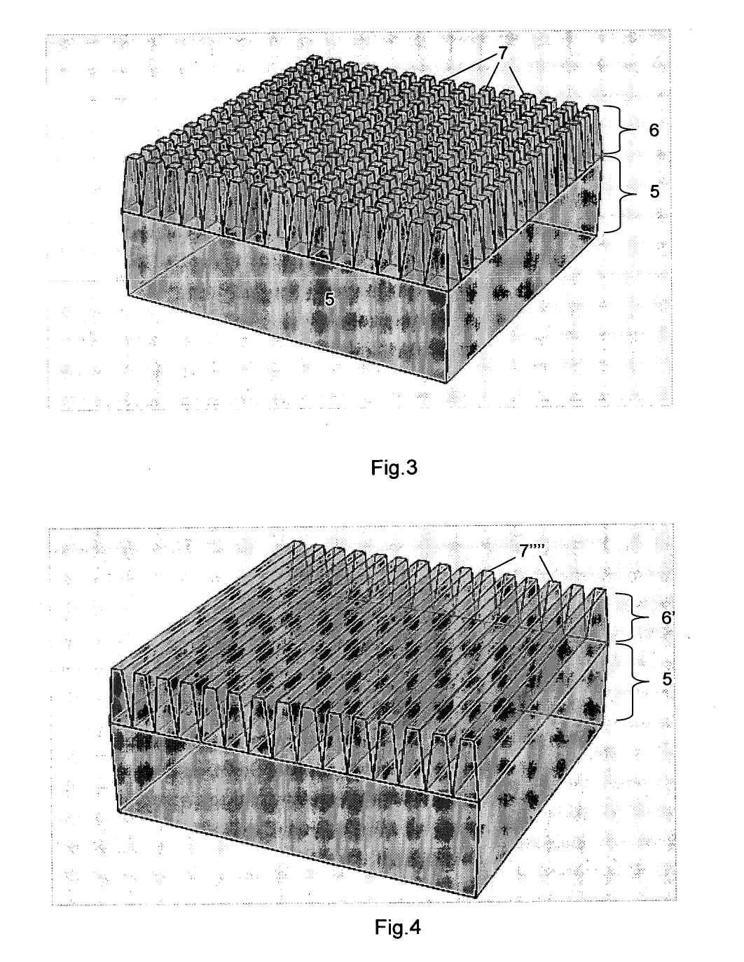

Finally, if the sustain electrodes are positioned between these plates, as in FIGS. 3 and 4 of this document, it is found that the thickness of the dielectric layer (the layer referenced 123) on top of the sustain electrodes increases as one goes further away from the discharge initiation edge. This results in a reduction in the electrical capacitance upon moving away from this initiation edge, this being contrary to obtaining good luminous efficiency of the discharges, as taught by document WO 2004/001786.

An object of the invention is to overcome one or more of the above-mentioned drawbacks.

For this purpose, the subject of the invention is an image display comprising a front panel, an array of optical concentrators, and an array of plasma discharge cells capable of emitting light through said front panel and through the concentrators of said array, where each plasma discharge cell is optically coupled to at least one concentrator and where each concentrator operates by reflection.

The light emission from the cells of the display is adapted in a manner known per se in order to display the images.

The concentrators of the display operate by reflection, unlike the concentrators described in document EP 1 526 561 which, being formed from lenses, operate by refraction. Thanks to the use of reflecting concentrators the constraints of aligning the lenses with the diaphragms of these lenses, as in EP 1 526 561, are advantageously avoided.

In general, each concentrator comprises a light entry section, a light exit section and reflecting side walls that are bounded by the entry section and by the exit section.

The side walls of each concentrator are reflecting for the light that is emitted by a cell and that penetrates said concentrator via the entry section. The rays that leave each concentrator have passed through it either directly, without being reflecting, or, on the contrary, after one or more reflections off its side walls.

According to a first variant, the reflecting side walls of the concentrators are formed by the interface between two transparent materials of different optical indices, and the shape of these walls and the difference between these optical indices are adapted so that the emitted light rays that strike said walls coming from the interior of said concentrator and from its entry section are reflected by total internal reflection off said walls. According to a second preferred variant, the reflecting side walls are metallized. Any emitted light ray that strikes these walls coming from the interior of said concentrator is then reflected off these walls.

Each plasma discharge cell of the display is optically coupled to at least one concentrator via its entry section.

All the side walls of the concentrators are not necessarily reflecting. In the case of a display comprising cells distributed in rows and/or columns, each concentrator may be common to all of the cells of any one row or any one column. This concentrator then comprises two opposed reflecting side walls, the other two side walls of this concentrator being shifted to the ends of the row or of the column, and not necessarily being reflecting. The entry section of the concentrator is then optically coupled to a plurality of cells. In this configuration, each cell of the row therefore “sees” only two portions of opposed reflecting walls of this concentrator.

Even if each plasma discharge cell is optically coupled to a plurality of concentrators, each concentrator may also be common to several cells.

According to the invention, the concentrators are bonded to one and the same layer.

The array of concentrators is preferably formed in a sheet of transparent plastic, for example by thermoforming. Such a process is particularly inexpensive. To obtain concentrators whose side walls are reflecting, this plastic sheet is metallized, before or after forming.

In general, all the entry sections of the concentrators are coplanar and form the inner face of the layer of concentrators, and all the exit sections of the concentrators are coplanar and form the outer face of the layer of concentrators, which face is directed towards the observer of the images to be displayed.

According to the invention, the layer of concentrators includes electromagnetic screening means. In this case, it is the layer of concentrators itself that integrates the electromagnetic screening means. Advantageously an additional layer, especially for the screening, is avoided and the manufacture of the display is therefore simplified. For example, conductors between the concentrators are integrated in the layer of concentrators. As conductors, metallized plastic fibres may be used. If the array of concentrators is formed in a transparent plastic sheet, to obtain such screening means a conducting plastic resin, for example one filled with conducting particles, is applied, for example in the gaps between the concentrators. Furthermore, to obtain a contrast-enhancing black matrix, the resin is also filled with black pigment.

Preferably, the layer of concentrators is integrated into the front panel itself, for example in a manner similar to the plastic electromagnetic screening layer described for example in document EP 0 917 174. This layer is then bonded to a glass plate which forms walls at the cells of the display. Another thin glass plate may be laid on top of this layer of concentrators, in a manner similar to that described in document EP 0 908 920. The layer of concentrators is then interposed between two glass plates, which form part of the front panel. Thanks to the integration of the layer of concentrators in the front panel, either on the periphery or in the centre of this panel, the distance between these concentrators and the cells of the display is reduced, thereby advantageously reducing any parallax defects between the concentrators and the cells of the display.

On the other hand, more conventionally, the front panel may be interposed between the array of cells and the layer of concentrators. Thus, the layer of concentrators is applied to the opposite side of the front panel from that where the array of cells is located.

Preferably, the reflecting side walls of the concentrators are metallized. In general, the metallized layer is such that the reflecting side walls of the concentrators of the array are electrically connected together. Thus, the metallization layer advantageously has two functions, namely reflection and electromagnetic screening.

According to a variant, the display further includes an electromagnetic screening layer that is conducting, this being placed on said outer face of the layer of concentrators and includes holes corresponding to said exit sections, for passage of the light emitted by the cells. Such a conducting layer may be obtained by depositing a metal, such as aluminium, by vacuum evaporation followed by chemical or electrochemical etching in order to drill holes into the coating. Such a conducting layer may also serve as contrast layer capable of absorbing the ambient light. An anodizing treatment carried out on the metal layer makes it possible, for example, to obtain such an absorbent layer.

According to a variant, since all the exit sections of the concentrators are coplanar and form the outer face of the layer of concentrators, the display includes a contrast layer that is capable of absorbing the ambient light, which is placed on said outer face of the layer of concentrators and includes holes corresponding to said exit sections, for passage of the light emitted by the cells. This contrast layer thus provides means capable of absorbing the ambient light striking the layer of concentrators between said concentrators. Thanks to the concentrators, it is possible to apply the contrast layer to a large area without the display losing luminance. This makes it possible for the contrast in ambient light when displaying images to be very considerably enhanced.

Preferably, the layer of concentrators itself includes means capable of absorbing the ambient light striking said layer between said concentrators. These light-absorbing or light-masking means form what is generally called a black matrix for enhancing the contrast in ambient light. Thanks to the concentrators, the area available for applying this black matrix without loss of light is much larger than in the prior art. This makes it possible for the contrast in ambient light when displaying images to be very considerably enhanced.

In this case, it is the layer of concentrators itself that integrates the means capable of absorbing the ambient light. Advantageously, an additional layer, especially for the contrast is avoided and the manufacture of the display is therefore simplified. If the array of concentrators is formed in a transparent plastic sheet, to obtain such absorption means an absorbent plastic resin, for example one filled with black pigment, is applied, for example in the gaps between the concentrators.

Preferably, for each concentrator, the light exit section has a smaller area than the entry section. Thus, a concentration effect is achieved.

Preferably, to obtain the concentration effect, the reflecting side walls of each concentrator are turned towards its entry section. This means that the normal at any point on said reflecting walls cuts this entry section, passing via the interior of the concentrator, or, otherwise, is parallel to this entry section.

Preferably, the reflecting side walls of each concentrator have a suitable shape so that any emitted light ray which penetrates via its entry section, which is reflected at least once off said side walls and which emerges from said concentrator via its exit section, emerges therefrom at an angle of emission greater than the angle of emission of this ray at the entry of this concentrator. Thus, the angular distribution of the emission intensity is advantageously widened.

The definition of the shape of the reflecting side walls includes that of the depth of the concentrators, that is to say the distance between the entry section and the exit section of these concentrators. It also includes the shape and the area of these sections, the edges of which delimit these walls.

Preferably, the reflecting side walls of each concentrator are pairwise symmetrical with respect to a plane oriented in a direction that is normal to the display, or the reflecting side walls have an axis of symmetry.

In the case of a concentrator as mentioned above, which is common to all the cells of any one row or any one column of a display, this concentrator then has two opposed reflecting side walls that are symmetrical with respect to a plane parallel to said row or to said column.

In the case of rectangular or square entry and exit sections, there is generally a first pair of opposed side walls that are symmetrical with respect to a first plane, and a second pair of opposed side walls that are symmetrical with respect to a second plane, perpendicular to the first.

According to a preferred first variant, each of the two lines of intersection of the side walls with any section plane of this wall, which plane is oriented in a direction that is normal to the display and is perpendicular to said plane of symmetry or, in the case of the axis of symmetry, with any section plane passing through said axis of symmetry, forms a straight line or a parabola, the axis of which lies along said normal direction.

Such shapes allow the concentration effect to be optimized. In the case of walls having an axis of symmetry, these reflecting side walls then form a cone or a paraboloid.

According to a second preferred variant, each of the two lines of intersection of the side walls with any section plane of this wall, which plane is oriented in a direction that is normal to the display and is perpendicular to said plane of symmetry, or, in the case of the axis of symmetry, with any section plane passing through said axis of symmetry, lies within the area bounded by:
on the one hand, a straight line joining the point common to said line of intersection and to said entry section and the point common to said line of intersection and to said exit section; and
on the other hand, a parabola, the axis of which is approximately parallel to the straight line joining the latter common point and the point common to the other line of intersection, which is symmetrical with the previous one, and to said entry section, and the focus of which coincides approximately with the point common to this other line of intersection and to said exit section.

The parabolas thus defined are termed “CPC (compound parabolic concentrator)” parabolas. Included within this area here are the contours of this area.

Preferably, each of the two lines of intersection of said side walls with the section plane coincide approximately with this CPC parabola. It should be pointed out that the normal to each CPC-type parabola in said section plane, at the common point E, E′ of this parabola and of the edge of the entry section of said concentrator, is perpendicular to said plane of symmetry or to said axis of symmetry.

The side walls then form a CPC, thereby allowing the concentration efficiency to be optimized.

The extreme ray of such a concentrator is defined as follows: this extreme ray lies within said section plane and is defined as the ray that passes, on the one hand, through the point common to the edge of the entry section of the concentrator and of a first line of intersection of the reflecting side walls of this concentrator with this section plane and, on the other hand, through the point common to the exit section and of a second line of intersection of the walls with this section plane, which is symmetrical with the first with respect to said plane of symmetry or to said axis of symmetry.

The work entitled “High Collection Nonimaging Optics”, by W. T. Welford & R. Winston, Academic Press, Inc., 1989 precisely defines the shape of the side walls of a CPC-type concentrator, and also its depth and the ratio of the areas of the entry and exit sections—see in particular paragraph 3 of chapter 4 of this work. If 2a′ is the distance between two opposed edges of the exit section of a concentrator of this CPC type in the section plane defined above, if 2a is the distance between two opposed edges of the entry section, again in this section plane, and if θₘₐₓ is the angle of the extreme ray relative to the direction normal to the display, then these three parameters are related through the equation: a=a′/sin θₘₐₓ. The depth L of the concentrator, that is to say the distance between the entry section and the exit section, is expressed by the equation: L=(a+a′)cos θₘₐₓ.

In practice, the emitted light rays have a limiting angle of emission θₗᵢₘ, in particular if the index of the material of the front panel and of the concentrator is n_{d}, then sin θₗᵢₘ=1/n_{d}. Preferably, the geometry of the concentrators is adapted so that θₘₐₓ=θₗᵢₘ. This makes it possible to limit the loss of emitted light.

Preferably, each plasma discharge cell is optically coupled to a plurality of concentrators, preferably to at least four concentrators. These concentrators are then preferably affixed so that their entry sections cover the entire emissive surface of the display. For manufacturing the display, the alignment constraints when applying the layer of concentrators to the front panel are thus advantageously avoided. It is thus possible to use thinner layers of concentrators. Finally, by thus increasing the density of concentrators, a tighter network of electromagnetic screening conductors, and therefore more effective screening, is achieved. Preferably, none of the dimensions of the entry section of the concentrators is greater than 100 μm. This therefore further improves the electromagnetic screening.

In general, the display according to the invention also includes a rear panel, which is placed, relative to the front panel, so as to leave between the front and rear panels a space comprising said plasma discharge cells. The display preferably includes an array of barriers defining, at least in part, said cells. Preferably, the rear panel includes an array of address electrodes distributed so that each cell is traversed by an address electrode.

Preferably, the front panel includes two arrays of sustain electrodes which are distributed so that each cell is traversed by an electrode of each sustain array. Preferably, each cell is positioned at a point where an address electrode crosses over an electrode of each sustain array. Preferably, the walls of the cells, especially the rear panel and the barriers, are covered with phosphors capable of emitting visible light under the excitation of the plasma discharges. Within each cell, it is therefore the phosphors that emit light towards the entry section of at least one concentrator to which this cell is optically coupled.

The invention will be more clearly understood on reading the following description, given by way of non-limiting example and with reference to the appended figures in which:

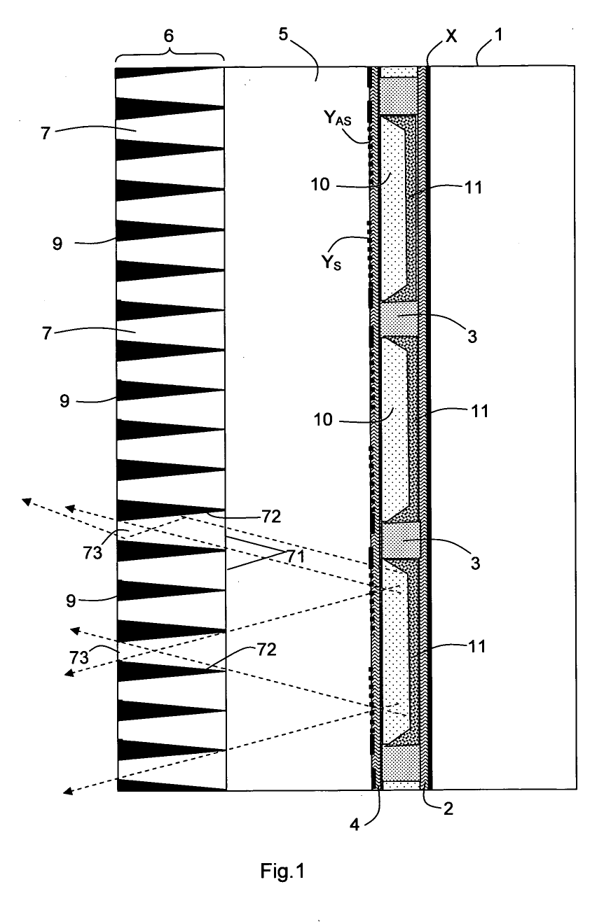

FIG. 1 is a cross-sectional view of a plasma display according to one embodiment of the invention;

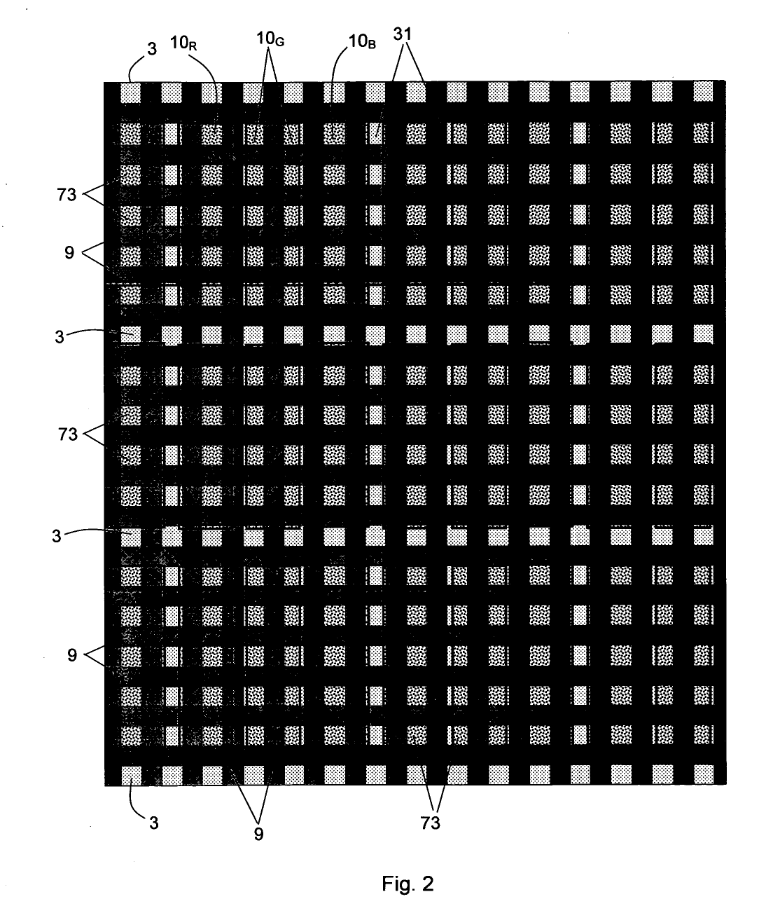

FIG. 2 is a top view of the display of FIG. 1, in which the contrast enhancement array has been shown as if it were slightly transparent, purely to reveal the array of subjacent cells;

FIG. 3 is a simplified view in perspective of the front panel and of its array of concentrators of the display shown in FIG. 1;

FIG. 4 is a simplified view in perspective of the front panel of the display shown in FIG. 1, with a variant of the array of concentrators in which each concentrator is common to a row of cells of the display;

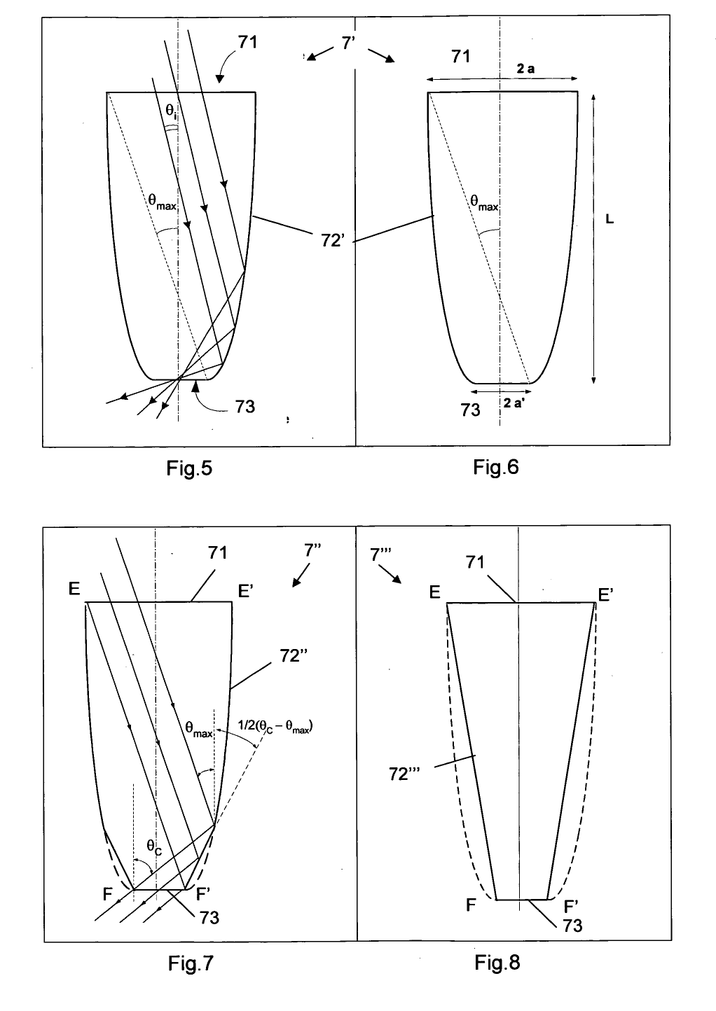

FIGS. 5 to 8 illustrate variants of the shape of the intersections of a normal section plane with the side walls of a concentrator for a display according to the invention: CPC shape in FIGS. 5 and 6; truncated CPC shape in FIG. 7; and trapezoidal shape lying within a CPC shape in the case of FIG. 8; and

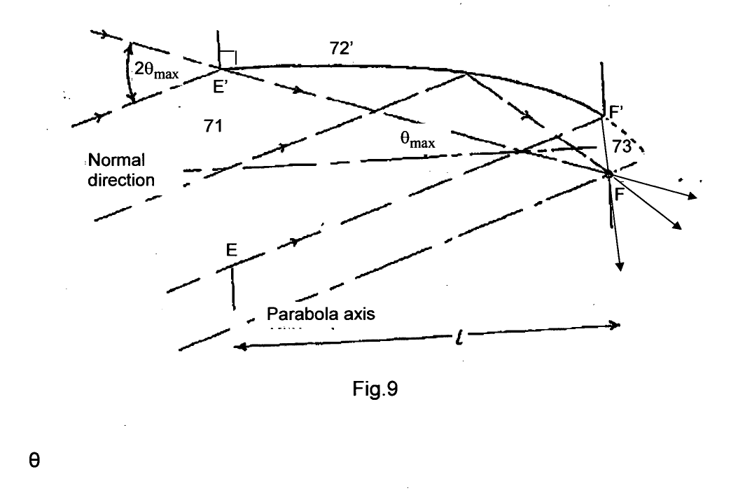

FIG. 9 illustrates the ray tracing for a CPC-type parabola between an entry section and an exit section of a concentrator according to the variant shown in FIGS. 5 and 6.

Referring to FIGS. 1 and 2, the display according to the invention comprises a rear panel 1, a front panel 5 and an array of barriers 3, 31 defining plasma discharge cells 10 between the panels.

The rear panel 1 includes an array of address electrodes X that are distributed so that each cell 10 is traversed by an address electrode. This array of address electrodes is covered with a dielectric layer 2. The front panel includes two arrays of sustain electrodes Y_{AS}, Y_{S} that are distributed so that each cell 10 is traversed by an electrode of each sustain array. Each sustain electrode Y_{AS}, Y_{S} includes a transparent part (shown dotted in the figure) and an opaque part, (shown solid in the figure) for distributing the current. These arrays of sustain electrodes are covered with a dielectric layer 4 and with a very thin protective secondary-electron-emitting layer, generally based on magnesia (not shown in the figure). Each cell 10 is positioned in this display at a crossover between an address electrode X and an electrode Y_{AS}, Y_{S} of each sustain array. Finally, in each cell, the bottom corresponding to the rear panel and the flanks of the barriers corresponding to the side walls are covered with a layer of phosphors capable of emitting visible light, here in the red, green or blue, under the excitation of the UV radiation from the plasma discharges. In FIG. 2, the plasma discharge cells are distinguished according to their emission colour: 10_{R} for the red, 10_{G} for the green, and 10_{B} for the blue. In FIG. 1, the generic reference 10 has been used to denote a cell independently of its emission colour.

One of the faces of the front panel 5 therefore supports the arrays of sustain electrodes and the dielectric layer 4. According to the invention, the other face of this panel supports a layer 6 of concentrators 7 operating by reflection.

Each concentrator 7 comprises a square light entry section 71, a square light exit section 73 and reflecting side walls 72 that are bounded by the entry section 71 and by the exit section 73. To obtain the desired concentration effect, the area of the exit section 73 is smaller than that of the entry section 71. In the embodiment described, each cell 10 is optically coupled to a plurality of concentrators 7 via the entry section 71 of these concentrators. One advantage of such an arrangement is that it reduces the thickness of the layer 6 of concentrators and limits the alignment constraints when applying the layer 6 of concentrators to the front panel.

In the embodiment described, the reflecting side walls 72 of the concentrators are metallized. Any emitted light ray that strikes these walls coming from the interior of a concentrator is then reflected off these walls. The rays that leave each concentrator have passed through it either directly, without being reflected, or, on the contrary, after one or more reflections off its side walls.

In the embodiment described, the reflecting side walls 72 of the concentrators are plane and form trapezia as illustrated in FIG. 3. The reflecting side walls of each concentrator are turned towards its entry section 71. This means that the normal at any point on the reflecting walls 72 cuts this entry section 71, passing via the interior of the concentrator.

Since the area of the exit section 73 is smaller than that of the entry section 71, it may be seen that the area available for a contrast layer between its exit section 73 is greater than in the prior art. This very considerably enhances the contrast in ambient light when images are being displayed by the display.

Referring to FIG. 3, each concentrator 7 of the layer 6 therefore forms a truncated cone of square cross section, which therefore has two perpendicular planes of symmetry that are oriented in a normal direction. Referring to FIG. 1, the emissive surface of each cell, which corresponds to the layer of phosphors in this cell, is optically coupled to the entry section of several concentrators 7 via the transparent front panel 5.

In the embodiment described in FIGS. 1 to 3, the gaps between the concentrators are filled with an absorbent conducting resin so as to form a matrix 9 serving both as means of enhancing the display contrast in ambient light and as electromagnetic screening.

To manufacture the plasma display according to the invention, the process starts with a plasma display known from the prior art.

A layer 6 of concentrators is also prepared. By compression moulding a sheet of transparent thermoformable polymer such as PMMA (polymethyl methacrylate), an array of truncated cones, as defined above, is formed in this sheet. The entire sheet is then metallized on the exit section side, masking these exit sections, thus the reflecting walls of the concentrators are obtained. A resin filled with black pigment and with conducting particles is applied in the gaps left by moulding between the concentrators, which resin forms an array of conductors lying between the concentrators. Thus an absorbent conducting matrix 9 is obtained that serves both for contrast enhancement and for electromagnetic screening. Compared with the prior art, application of a specific layer for the contrast in ambient light, called the “black matrix”, is avoided. Also avoided are the constraints for aligning the holes in this layer, as in document EP 1 526 561. It should be noted that the metallization itself advantageously contributes to the electromagnetic screening.

The layer 6 of concentrators thus obtained is joined to the front panel 5 of the plasma display using an adhesive suitable for optically coupling the cells of the display to the entry section 71 of the concentrator 7.

The plasma display obtained according to the invention thus provides an array of concentrators with no constraint on the thickness of the dielectric layer that covers the sustain electrodes. It is thus possible to adapt the thickness of this layer according to other constraints, especially that of improving the luminous efficiency of the discharges.

The cells of the display are generally distributed in vertical columns and horizontal rows. All the cells of any one column generally have the same emission colour, that is to say the same phosphor.

FIG. 4 shows an alternative embodiment of the display according to the invention that has just been described: each concentrator 7′ of the layer 6′ is common to all the cells of any one column and possesses a single plane of symmetry oriented in a direction perpendicular to the display and parallel to this column. What is obtained is a display whose viewing angle is, thanks to the shape of the concentrators, broadened here only in a horizontal plane. Preferably, all the cells of any one column are optically coupled to a single concentrator. Since the horizontal dimension of the cells is in general very much less than their vertical dimension, the array of vertical conductors placed between the cells is sufficient to provide effective electromagnetic screening.

In a preferred alternative form shown in FIGS. 5 and 6, the reflecting side walls of the concentrators are of the CPC type. More precisely in this case, the intersection of the side walls 72′ of each concentrator 7″″ with a section plane perpendicular to any plane of symmetry of the concentrator forms a CPC-type parabola, in the case of concentrators having an axis of symmetry, and this section plane then passes through this axis. FIG. 9 shows in detail the characteristics of the ray tracing for a CPC-type parabola in which the points E and E′ represent the edges of the entry section of the concentrator and the points F and F′ represent the edges of the exit section, in which the parabola that follows the line F′E′ has the point F as focus and a straight line parallel to F′E passing through F as axis, and in which the parabola that follows the line FE has the point F′ as focus and a straight line parallel to FE′ passing through F′ as axis.

One property of such CPC parabolas is that, in the section plane, the tangent to the point of each parabola that lies at its intersection with the entry section, here at the points E and E′, is parallel to the normal direction, and therefore here perpendicular to the planes of the entry and exit sections.

The advantage of the CPC parabola shape of this section of the concentrator is that it optimizes the concentration of the rays that are emitted by the cells at an angle of emission at or below the angle θₘₐₓ that an extreme ray EF′ or E′F makes with the direction normal to the display.

According to other variants, such as that shown in FIG. 7, the reflecting side walls 72″ of the concentrators have a shape intermediate between the plane shape 72′″ shown in FIG. 8 and the CPC shape described above and shown in FIGS. 5, 6 and 9. More precisely in this case, the intersection of the side walls 72″ of each concentrator 7″ with a section plane perpendicular to any plane of symmetry of this concentrator (or any plane passing through its axis of symmetry) lies within the area bounded by the straight line EF and the CPC parabola passing through the points E and F, and within the area bounded by the straight line E′F′ and the CPC parabola passing through the points E′ and F′. These boundaries—straight lines and parabolas—are considered to lie within these areas. Advantageously, such “intermediate” shapes are simpler to manufacture than CPC shapes, while still providing performance levels that are very acceptable.

The present invention has been described with reference to a plasma display with coplanar sustain electrodes for displaying images, but it is obvious to a person skilled in the art that the invention may apply to other plasma displays, without departing from the scope of the claims hereinbelow.

1. Image display comprising a front panel, an array of optical concentrators operating by reflection, and an array of plasma discharge cells capable of emitting light through said front panel and through the concentrators of said array, where each plasma discharge cell is optically coupled to at least one concentrator wherein said concentrators are bonded to one and the same layer which includes electromagnetic screening means.

2. Display according to claim 1, wherein each concentrator comprises a light entry section, a light exit section and reflecting side walls that are bounded by said entry section and by said exit section.

3. Display according to claim 2, wherein said reflecting side walls of the concentrators are metallized.

4. Display according to claim 2, wherein said light exit section has a smaller area than said entry section.

5. Display according to claim 4, wherein the reflecting side walls of each concentrator have a suitable shape so that any emitted light ray which penetrates via its entry section, which is reflected at least once off said side walls and which emerges from said concentrator via its exit section, emerges therefrom at an angle of emission greater than the angle of emission of this ray at the entry of this concentrator.

6. Display according to claim 4, wherein said reflecting side walls of each concentrator are pairwise symmetrical with respect to a plane oriented in a direction that is normal to the display, or in that said reflecting side walls have an axis of symmetry.

7. Display according to claim 6, wherein, each of the two lines of intersection of said side walls with any section plane of this wall, which plane is oriented in a direction that is normal to the display and is perpendicular to said plane of symmetry or, in the case of the axis of symmetry, with any section plane passing through said axis of symmetry, forms a straight line or a parabola, the axis of which lies along said normal direction.

8. Display according to claim 6, wherein each of the two lines of intersection of said side walls with any section plane of this wall, which plane is oriented in a direction that is normal to the display and is perpendicular to said plane of symmetry, or, in the case of the axis of symmetry, with any section plane passing through said axis of symmetry, lies within the area bounded by:
on the one hand, a straight line joining the point common to said line of intersection and to said entry section and the point common to said line of intersection and to said exit section; and
on the other hand, a parabola, the axis of which is approximately parallel to the straight line joining the latter common point and the point common to the other line of intersection, which is symmetrical with the previous one, and to said entry section, and the focus of which coincides approximately with the point common to this other line of intersection and to said exit section.

9. Display according to claim 1, wherein said layer of concentrators includes means capable of absorbing the ambient light striking said layer between said concentrators.

10. Display according to claim 1, wherein said layer of concentrators is integrated into the front panel itself.

11. Display according to claim 1, wherein each plasma discharge cell is optically coupled to a plurality of concentrators.
